(19) United States
(12) Patent Application Publication
(10) Pub. No.: US 2011/0147462 A1
(43) Pub. Date: Jun. 23, 2011

(54) Transponder-Thread and Application Thereof

(76) Inventor: Francisco Speich, Gipf-Oberfrick (CH)

(21) Appl. No.: 11/884,742

(22) PCT Filed: Jan. 18, 2006
(86) PCT No.: PCT/CH2006/000040

§ 371 Date: Aug. 21, 2008

(30) Foreign Application Priority Data
Feb. 23, 2005 (CH) 316/05

(51) Int. Cl. G06K 19/077

(52) U.S. Cl. 235/492

(57) ABSTRACT

According to the invention, the fitting of a transponder (4a) to a flat object may be simplified, whereby the same is embodied as a transponder thread, comprising a chip (6) and an attached antenna (8, 10).

This application claims priority of PCT application PCT/CH2006/000040 having a priority date of Feb. 23, 2005, the disclosure of which is incorporated herein by reference.

### TECHNICAL FIELD

The invention relates to a transponder thread comprising at least one transponder and to a use of the transponder thread.

### BACKGROUND OF THE INVENTION

Transponders are familiar receiving/transmitting devices which carry information and operate in accordance with the challenge-response system and operate in conjunction with a mobile or stationary reader. A transponder contains a chip and an antenna. A microelectronic component which fulfils the tasks of the transponder is a corresponding chip. In contrast to an active transponder, a passive transponder does not need a battery and accordingly has a virtually unlimited life.

Such transponders exhibit the most varied technologies and are used for the most varied purposes such as, e.g. the identification of the location of a carrier or as theft protection for products in shops. They can also be used for stock keeping if the transponder contains product-specific data which are forwarded to a stock controller.

It is known to connect such transponders to woven or knitted flat textile structures and is trendy. Connecting the transponder chips to a flat textile structure and arranging an antenna required for transmitting and/or receiving signals provides problems. Thus, it is known to provide a flat textile structure with antennas at which the chip is then to be attached. Such a production is very difficult, particularly because of the miniaturized components which have an order of magnitude of millimeters or fractions thereof.

### SUMMARY OF THE INVENTION

It is the object of the invention to simplify the arrangement of a transponder at a flat textile structure.

The object is achieved by the transponder thread which contains at least one transponder of a chip and a connected antenna. Such a transponder thread can then be connected in a simple manner to a flat textile structure, e.g. by weaving or knitting, so that the flat textile structure, e.g. a label, is already operable after the weaving or knitting process. There is no subsequent attachment of a chip to antennas. Accordingly, the use of the transponder thread at a label in such a manner that at least one transponder is arranged at the label is also the subject matter of the invention.

A transponder can have a chip with a one-piece antenna. However, the transponder thread is preferably constructed in such a manner that the antenna consists of two antenna parts between which the chip is arranged.

The transponder thread can have a number of transponders arranged behind one another, in each case with a chip and a connected antenna so that the transponder thread can be processed like a normal thread during weaving or knitting. The transponder thread can consist only of combined transponders so that the chips appear to be strung up on the antenna virtually in the manner of a string of pearls. The transponders can also be arranged in or at a preferably textile basic structure. If the transponders have antenna parts which extend in one piece between their chips these must be separated in the further processing of the transponder thread.

The individual transponders can also be arranged independently of one another.

The antenna can consist of a conductive thread. It is possible to form the antenna from braided conductive threads. It is also possible to arrange the antenna around a thread core.

The transponder thread can have the most varied shapes and have, for example, a round cross section or also a flat cross section. In the latter case, the transponder can be arranged with the chip and the antenna on one side of a basic structure. In this arrangement, it can be of advantage if the transponder thread is folded along the center line, so that the basic structure encloses the transponder with its chip and its antenna.

In the production of a label, the transponder thread can be arranged as warp. It is also possible to arrange the transponder thread as weft. The transponder thread can be arranged by being woven or knitted in. It is also possible to arrange the transponder thread in the sense of a figuring weft thread floating on the rear of the label.

### BRIEF DESCRIPTION OF THE DRAWINGS

In the text which follows, exemplary embodiments of the invention will be described in greater detail with reference to the drawings, in which:

FIG. 1 shows a first transponder thread consisting only of chips and antenna parts; in plan view;

FIG. 2 shows a second transponder thread with a transponder arranged in a round basic structure, in longitudinal section;

FIG. 3 shows a third transponder thread with a transponder arranged at a flat basic structure, in plan view; and

FIG. 4 shows labels with thread-like transponder thread in plan view.

### DETAILED DESCRIPTION OF THE PREFERRED EMBODIMENT

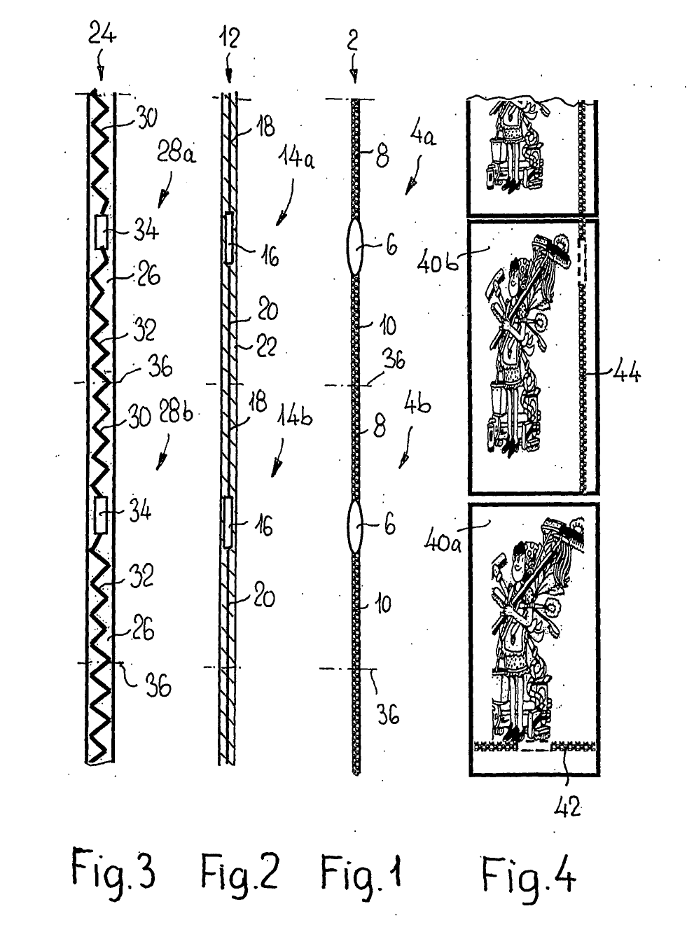

FIG. 1 shows a transponder thread 2 which has transponders 4a, 4b hanging together virtually in the manner of string of pearls. Each transponder contains a chip 6 at which antenna parts 8, 10 are arranged at mutually opposite sides, which are in each case connected in one piece to the antenna parts of the adjacent transponder. The antenna parts 8, 10 consist, for example, of a single conductive thread or of threads braided together and have a round cross section and are open, that is to say not embedded in a basic structure.

FIG. 2 shows a further transponder thread 12 with transponders 14a, 14b strung together, the chips 16 and antenna parts 18, 20 of which are embedded in a basic structure 22. Such a basic structure can consist, for example, of fibers spun together or of a covering of plastic.

FIG. 3 shows a strip-shaped transponder thread 24 which has a strip-shaped basic structure 26 at which the transponders 28a, 28b are arranged. The strip-shaped basic structure can consist, for example, of a fiber fleece or a plastic band such as, for example, a lurex thread. The antenna parts 30, 32 are arranged in zigzag manner between the chips 34 in order to accommodate a length of the antenna which is greater than the given length of the basic structure 26. The antenna can be formed, for example, by etching a metal layer applied to the basic structure.

The transponder threads shown in FIGS. 1 to 3 can be worked in like normal threads in a flat textile structure, for example as weft threads or warp threads or possibly as knitting thread. As a rule, the antenna parts going through between two chips must be separated half way along as is indicated by the dot-dashed separating lines 36 in the figures.

With regard to the length of the antenna parts, a flat textile structure to be produced, especially a label comprising such a transponder thread, must be configured in such a manner that the transponder present in the section of the transponder thread has an antenna, the length of which ensures adequate operation of the chip, that is to say is tuned to it. Thus, an antenna length of approx. 17 cm is needed, e.g. for transponders in the UHF band.

FIG. 4 shows various labels 40a, 40b in which, e.g., such a transponder thread is arranged as weft 42 or as warp 44. As a rule, such a label will have a single transponder. However, it is also possible that a label contains two and more transponders having different properties and for different purposes. Thus, one transponder can be used, e.g. for theft protection whilst another transponder can be used for stock keeping.

### LIST OF REFERENCE DESIGNATIONS

2 transponder thread
4a transponder
4b transponder
6 chip
8 antenna part
10 antenna part
12 transponder thread
14a transponder
14b transponder
16 chip
18 antenna part
20 antenna part
22 basic structure
24 transponder thread
26 basic structure
28a transponder
28b transponder
30 antenna part
32 antenna part
34 chip
36 separating line
40a label
40b label
42 weft
44 warp

1-10. (canceled)

11. A transponder thread which can be processed by weaving or knitting, which contains at least one transponder of a chip and a connected antenna wherein the antenna consists of two antenna parts between which the chip is arranged, characterized in that it contains a number of transponders arranged behind one another, in each case of a chip and a connected antenna.

12. The transponder thread as claimed in claim 11, characterized in that it only consists of the transponder(s).

13. The transponder thread as claimed in claim 11, characterized in that the transponders are arranged in a textile basic structure.

14. The transponder thread as claimed in claim 11, characterized in that the transponders are arranged independently of one another.

15. The transponder thread as claimed in claim 11, characterized in that the transponders have between their chips antenna parts which extend in one piece and which are separated in the further processing of the transponder thread.

16. The transponder thread as claimed in claim 11, characterized in that the antenna consists of a conductive thread.

17. The transponder thread as claimed in claim 11, characterized in that the antenna consists of braided conductive threads.

18. The transponder thread as claimed in claim 13, characterized in that the antenna is arranged around a thread core of the basic structure.

19. The transponder thread as claimed in claim 13, characterized in that it is constructed to be flat, the transponder with the chip and the antenna being arranged on one side of the basic structure constructed to be flat.

20. The transponder thread as claimed in claim 19, characterized in that it is folded along its center line.

21. Use of the transponder thread as claimed in claim 11 in a label in such a manner that at least one transponder is arranged at the label.

22. The use as claimed in claim 21, characterized in that the transponder thread is arranged in the label as warp.

23. The use as claimed in claim 21, characterized. in that the transponder thread is arranged in the label as weft.

24. The use as claimed in claim 21, characterized in that the transponder thread is arranged floating on the rear of the label.

25. The transponder thread as claimed in claim 12, characterized in that the transponders are arranged in a textile basic structure.

26. The transponder thread as claimed in claim 12, characterized in that the transponders have between their chips antenna parts which extend in one piece and which are separated in the further processing of the transponder thread.

27. The transponder thread as claimed in claim 13, characterized in that the transponders have between their chips antenna parts which extend in one piece and which are separated in the further processing of the transponder thread.

28. The transponder thread as claimed in claim 14, characterized in that the transponders have between their chips antenna parts which extend in one piece and which are separated in the further processing of the transponder thread.

29. The transponder thread as claimed in claim 13, characterized in that the antenna consists of a conductive thread.

30. The transponder thread as claimed in claim 13, characterized in that the antenna consists of braided conductive threads.
